(19) United States
(12) Patent Application Publication
(10) Pub. No.: US 2025/0067615 A1
(43) Pub. Date: Feb. 27, 2025

(54) A LEAK DETECTION SYSTEM FOR A WATER INSTALLATION

(71) Applicant: Martin Larsen, Virum (DK)

(72) Inventor: Martin Larsen, Virum (DK)

(21) Appl. No.: 18/724,888

(22) PCT Filed: Jan. 24, 2023
(86) PCT No.: PCT/DK2023/050011

§ 371 Date: Jun. 27, 2024

(30) Foreign Application Priority Data
Jan. 24, 2022 (DK) PA 2022 00064

(51) Int. Cl. G01M 3/00; G01M 3/28

(52) U.S. Cl. CPC G01M 3/002; G01M 3/2807

(57) ABSTRACT

A leak detection system for a water installation is disclosed. The leak detection system comprises a first temperature sensor (TS1) configured to provide a first signal representative of a first temperature T1 measured by said first temperature sensor; a second temperature sensor (TS2) configured to provide a second signal representative of a second temperature T2 measured by said second temperature sensor; a heating element (HE) and a control unit (CU). The first temperature sensor (TS1), said second temperature sensor (TS2) and said heating element (HE) are mounted onto a surface of a water pipe (P) in said water installation. The first temperature sensor (TS1) is configured to communicate a first temperature T1 to the control unit and the second temperature sensor (TS2) is configured to communicate a second temperature T2 to the control unit. The control unit (CU) is configured to apply the first temperature T1 and said second temperature T2 as input in a calculation of a leak value LV, according to a predetermined calculation method. Depending on the magnitude of the calculated leak value LV the control unit (CU) is able to distinguish between situations of water consumption, situations of no water consumption but leak, and situations of no water consumption and no leak in the water installation.

### FIELD OF THE INVENTION

The present invention relates in general to the field of water installations.

More specifically, the present invention relates in a first aspect to a leak detection system comprising a leak detection device in combination with a pipe segment.

In a second aspect the present invention relates to a use of a leak detection system according to the first aspect of the present invention.

In a third aspect the present invention relates to a water installation comprising the leak detection system according to the first aspect of the present invention.

In a fourth aspect the present invention relates to a structure comprising a water installation according to the third aspect.

In a fifth aspect the present invention relates to a method for detecting a leak in a water installation.

### BACKGROUND OF THE INVENTION

Water leakage from a water installation is a well-known problem encountered by building owners. At a general economic perspective, it is a much bigger problem than fire. A burst water pipe may impose damages which in average cost around €2,000 to fix. However, in severe cases repair costs will be much higher.

Normally a water pipe does not suddenly burst. Water leakage starts with a small leak which over time becomes bigger and bigger until the pipe finally bursts.

Accordingly, it is very important to detect even very small leaks, down to a level of a few drops per minute, in time.

In a global perspective enormous amounts of drinking water are wasted because of water leaks from water installations, and many initiatives has been taken to limit the waste in the future. Some of the initiatives are developing and improving methods and systems for detection of leakage at TDPM (tap drops per minute) level and to reveal leaks faster and more precisely by using AI technology.

According to the publication “Phyn Plus: New approach to water management in homes. Ilari Aho, Vice President, Uponor Corporation, REHVA Fellow, REHVA Journal, December 2019 (available on the following link: https://www.rehva.eu/rehva-journal/chapter/phyn-plus-new-approach-to-water-management-in-homes), a house owner is prepared to invest up to €500.00 in an efficient leakage detection solution.

Such a solution must be easy to install and use, without any requirement for special skills. It must be able to fit into existing water installations, it must be reliable and maintenance free, and provide an intuitive operation. The solution shall be able to detect leaks at micro-leak level (below 18 TDPM).

Until now, no existing systems can match such user requirements in a satisfactorily manner as no existing solution satisfies all of the above user requirements.

A straightforward method for revealing unusual water consumption is to measure the water flow in the main pipe and make sure that over time, not too much water is spent. When water is expected to be turned off, then one has to make sure that this is the case by verifying that leak is below a certain threshold level.

Many types of flow meter exist, and many different types of basic sensor methods are used. Known types of flowmeters are: differential pressure flowmeters, turbine flowmeters, variable area flowmeters, magnetic flowmeters, oscillatory flowmeters, target flowmeters, positive displacement flowmeters, ultrasonic flowmeters, insertion flowmeters, correlation flowmeters, open channel flowmeters, Coriolis flowmeters, and thermal flowmeters.

However, because of different technical limitations and price levels, it is only the following flow meter types: ultrasonic flowmeters, turbine flowmeters, and thermal flowmeters, which are practically available to private users.

Some ultrasonic flowmeters can, with limitations, be used on a pipe without reconstruction of the plumbing system of the associated water installation. This gives the ultrasonic method several benefits: the user can install the flowmeter by himself, it makes no pressure drop, expected lifetime is long, and it requires no maintenance. Other ultrasonic flowmeters must be built into the water installation by a professional plumber.

Turbine flowmeters must be built into the water installation by a professional plumber and could require a pressure reduction valve and/or water filter to be installed as well. The expected lifetime is limited and there is a risk that the turbine flowmeter will fail due to presence in the water of contaminant particles and due to mechanical wear. The service of a turbine flowmeter will have to be carried out by a professional plumber.

Thermal flowmeters have limitations in relation to the range of water flow and is not suitable for use as a flowmeter in a water installation in a building. However, they can be used to distinguish between and hence detect: no flow, small flow, or large flow of water in a water installation.

The basic methods for thermal mass flow sensors are often called CTA (Constant Temperature Anemometry), and CPA, (Constant Power Anemometry; In CTA tie heating effect needed to make a constant temperature increase of the water passing the heating element is measured. In CPA the temperature increase of the water passing a constant heating power is measured.

A thermal flowmeter must be installed by a professional plumber. It implies generation of a small pressure drop in the water installation, expected lifespan is long and requires almost no maintenance. Thermal flowmeters based on sensors located on the outside of a piece of pipe exist. One example is “He-ted Tube Design”. However, these types have limitations as to the type of pipe material, pipe size, the range of water flow, and they are not suitable for use as flowmeter in a building water installation in a building.

Accordingly, a need for a low-cost leak detection system persists which can be installed by a non-professional user and which is reliable and capable of revealing leaks at micro leak level (such as below 18 TDPM).

It is an objective of the present invention to provide technology which fulfils such a need.

### BRIEF DESCRIPTION OF THE INVENTION

This objective is fulfilled according to the first, the second, the third, the fourth and the fifth aspect of the present invention.

Accordingly, in a first aspect the present invention relates to a leak detection system for a water installation comprising a leak detection device in combination with a pipe segment, wherein said leak detection device comprises:
a first temperature sensor TS1 configured to provide a first signal representative of a first temperature T1 measured by said first temperature sensor;
a second temperature sensor TS2 configured to provide a second signal representative of a second temperature T2 measured by said second temperature sensor;
a heating element HE;
a control unit CU;
   wherein said first temperature sensor TS1, said second temperature sensor TS2 and said heating element HE are being mounted onto an surface of said pipe segment of a water pipe P for said water installation in such a way that in relation to an intended flow direction of water in said pipe segment, said second temperature sensor (TS2) is being arranged on said pipe segment at a position upstream in relation to said heating element, (HE) and is being arranged on said pipe segment at a position downstream in relation to said first temperature sensor (TS1);
   wherein said first temperature sensor TS1 is configured to communicate said first signal to said control unit CU, thereby making said control unit CU register said first temperature T1;
   wherein said second temperature sensor TS2 is configured to communicate said second signal to said control unit CU, thereby making said control unit CU register said second temperature T2;
   wherein said control unit CU is configured to repeatedly log the value of said first temperature T1 and said second temperature T2;
   wherein said control unit CU is configured to apply said first temperature T1 and said second temperature T2 as input in a calculation of a leak value LV, according to a predetermined calculation method;
   wherein said control unit CU is configured to determine that a situation of no water consumption, as represented by a value A of flow of water of 240 TDPM (tap drops per minute) or less, is present in case LV is above a first predetermined threshold temperature TT1; and
   wherein said control unit CU, in such a situation of no water consumption, is configured to detect that no leak, as represented by a value B of flow of water of 10 TDPM or less, is present in case LV is above a second predetermined threshold temperature TT2; and wherein said control unit CU, in such a situation of no water consumption, is configured to detect that a leak, as represented by a value C of flow of water of above the value B and below the value A, is present in case the leak value LV is above said first predetermined threshold temperature TT1 and below said second predetermined threshold temperature TT2;
   wherein TT2>TT1.

In a second aspect the present invention provides a use of a leak detection system according the first aspect of the invention for detecting a leak in a water installation.

In a third aspect the present invention relates to a water installation comprising a leak detection system according the first aspect of the invention.

In a fourth aspect the present invention relates to a structure comprising a water installation according to the third aspect of the invention.

In a fifth aspect the present invention provides a method for detecting a leak in a water installation; said method comprising the steps of:
i) supplying power to a heating element HE arranged at a position on the surface of a pipe P of said water installation;
ii) measuring a first temperature T1 of water flowing in said pipe at a location upstream of said heating element in relation to flow direction of the water flowing in said pipe;
iii) measuring a second temperature T2 of water flowing in said pipe at a location between the position of said heating element and the position of measuring said first temperature T1;
iv) optionally measuring a third temperature T3 corresponding the temperature of the air surrounding the pipe P;
v) repeatedly calculation of a leak value LV, according to a predetermined calculation method, wherein the magnitude of said leak value LV is being indicative of the presence of a leak and optionally also the magnitude of such a leak in said water installation; wherein the temperatures T1 and T2, and optionally also the temperature T3 are used as input in said calculation method;
vi) determine that a situation of no water consumption is present in case said leak value LV is above a first predetermined threshold temperature TT1;
vii) determine, in a situation of no water consumption, as determined in step vi), that no leak is present in case LV is above a second predetermined threshold temperature TT2; or detect that a leak is present in case LV is above said first predetermined threshold temperature TT1 and below said second predetermined threshold temperature TT2; wherein TT2>TT1.

With the present invention in its various aspects, it is possibly in a very simple and reliable way to determine the appearance or the presence of a leak in a water installation.

The present invention is primarily intended for use in water installations in private homes with the primary purpose of detection very small leaks in the range of a few tap drops per minute (TDPM), which could be indicative of a defect in the water installation, such as a beginning corrosion of part(s) of that water installation, and which may lead to severe damage by leaking water if not attended to.

### BRIEF DESCRIPTION OF THE FIGURES

FIG. 1 is a schematic diagram depicting an example of a setup of the leak detection system according to the first aspect of the present invention in a water installation.

FIG. 2 is a schematic drawing illustrating the impact on the temperature of the water flowing in a vertically arranged pipe P due to the presence of the heating element HE arranged thereon.

FIG. 3 is a schematic drawing illustrating the impact on the temperature of the water flowing in a horizontally arranged pipe P due to the presence of the heating element HE arranged thereon.

FIG. 4 is a schematic diagram illustrating the heat distribution in the water flowing in a water pipe under different magnitudes of flow of water in the pipe P and caused by power produced by heating element.

FIG. 5 is a schematic diagram illustrating the development over time of the water temperature of water being present in a pipe in a no-leak situation, beginning just after ending a situation of water consumption.

FIG. 6 is a schematic diagram illustrating the development over time of the water temperature of water being present in a pipe in a “micro leak” situation, beginning just after ending a situation of water consumption.

FIG. 7 is a schematic illustration illustrating the development over time of the water temperature of water being present in a pipe in a “small leak” situation, beginning just after ending a situation of water consumption.

FIG. 8 is a schematic diagram illustrating the heat distribution in the water flowing in a hot water pipe under different magnitudes of flow F in the pipe P and caused by the presence of the heating element HE.

### DETAILED DESCRIPTION OF THE INVENTION

### The First Aspect of the Present Invention

The first aspect of the present invention relates to a leak detection system for a water installation comprising a leak detection device in combination with a pipe segment, wherein said leak detection device comprises:
a first temperature sensor TS1 configured to provide a first signal representative of a first temperature T1 measured by said first temperature sensor;
a second temperature sensor TS2 configured to provide a second signal representative of a second temperature T2 measured by said second temperature sensor;
a heating element HE;
a control unit CU;
   wherein said first temperature sensor TS1, said second temperature sensor TS2 and said heating element HE are being mounted onto an surface of said pipe segment of a water pipe P for said water installation in such a way that in relation to an intended flow direction of water in said pipe segment, said second temperature sensor (TS2) is being arranged on said pipe segment at a position upstream in relation to said heating element, (HE) and is being arranged on said pipe segment at a position downstream in relation to said first temperature sensor (TS1);
   wherein said first temperature sensor TS1 is configured to communicate said first signal to said control unit CU, thereby making said control unit CU register said first temperature T1;
   wherein said second temperature sensor TS2 is configured to communicate said second signal to said control unit CU, thereby making said control unit CU register said second temperature T2:
   wherein said control unit CU is configured to repeatedly log the value of said first temperature T1 and said second temperature T2;
   wherein said control unit CU is configured to apply said first temperature T1 and said second temperature T2 as input in a calculation of a leak value LV, according to a predetermined calculation method;
   wherein said control unit CU is configured to determine that a situation of no water consumption, as represented by a value A of flow of water of 240 TDPM (tap drops per minute) or less, is present in case LV is above a first predetermined threshold temperature TT1; and
   wherein said control unit CU, in such a situation of no water consumption, is configured to detect that no leak, as represented by a value B of flow of water of 10 TDPM or less, is present in case LV is above a second predetermined threshold temperature TT2; and
   wherein said control unit CU, in such a situation of no water consumption, is configured to detect that a leak, as represented by a value C of flow of water of above the value B and below the value A, is present in case the leak value LV is above said first predetermined threshold temperature TT1 and below said second predetermined threshold temperature TT2;
   wherein TT2>TT1.

Accordingly, the principle of the present invention is to apply heat to the water being present in a water pipe and measure the temperature at two positions upstream, in relation to the direction of water flow in that pipe, to that heating element. Based on the temperature measured, a leak value can be determined which represent the magnitude of flow of water though the water pipe at the position corresponding to the positions of the heating element and the temperatures measured. From the magnitude of the leak value, it is accordingly possible to distinguish situations of no water consumption, situations of water consumption, situations of no leak, and various situations of varying amounts of leaks.

It should be noted that the leak value itself does not directly express the magnitude of a leak, such as for example in terms of number of tap drops per minute (TDPM). However, the magnitude of the leak value may be “translated” into such magnitudes of leak as expressed by e.g. number of tap drops per minute.

It should be understood that with the present invention it is not of interest to detect the magnitude of flow of water in the pipe segment, when water consumption is taken place, such as by deliberate making water flow through a water tap of the water installation.

On the contrary, with the present invention it is of interest to detect when situations of no water consumption is present, and during such situations it is of interest to detect whether any flow of water is taken place in that pipe segment and also during such situations to detect the magnitude of such flow of water.

A situation of water flowing through the pipe segment in situations of no water consumption is indicative that a leak is present in the water installation and the magnitude that flow of water during situations of no water consumption is indicative of the severity of such leak.

As indicated in the definition of the leak detection system of the first aspect of the present invention, a situation of no water consumption in the water installation is defined as a value A of flow of water through the pipe segment of 240 TDPM (tap drops per minute) or less.

Likewise, as indicated in the definition of the leak detection system of the first aspect of the present invention, in a situation of no water consumption in the water installation, a situation of no leak in the water installation is defined as a value B of flow of water through the pipe segment of 10 TDPM (tap drops per minute) or less.

This means that in a situation of no water consumption, a flow of water through the pipe segment being above the value B and below the value A, is indicative of a leak in the water installation.

Accordingly, this also implies that within the meaning of present invention, a situation with a flow of water through the pipe segment of above 240 TDPM (tap drops per minute) is considered as a situation of water consumption.

The exact values A, B and C of flow of water in the three situations can be chosen arbitrarily within the given limits as defined above in respect of the leak detection system according to the first aspect of the present invention.

Appropriate magnitudes of the values A, B and C of flow of water in the three situations may then be chosen in accordance with dimensions of the water installation and in accordance with the desired sensitivity of the leak detection system.

In the present description and in the appended claims the following definition may be adhered to: Weight of a tap drop of water=0.23 g.

In some embodiments of the leak detection system of the first aspect of the present invention, the following definitions may be adhered to:
A “no leak situation” corresponds to a number of tap drops per minute (TDPM) of [0-4];
A “micro leak situation” corresponds to a number of TDPM of ]4-18[;
A “small leak situation” corresponds to a number of TDPM of [18-180];
A “situation of water consumption” corresponds to a number of TDPM of >180.

In these ranges the magnitude of 180 tap drops per minute (TDPM) corresponds to the value A as defined in respect of the leak detection system of the first aspect of the invention; the magnitude of [0-4] tap drops per minute (TDPM) corresponds to the value B as defined in respect of the leak detection system of the first aspect of the invention, and the magnitude of ]4-18[ and/or [18-180] tap drops per minute (TDPM) corresponds to the value C as defined in respect of the leak detection system of the first aspect of the invention.

The above ranges of TDPM are somewhat arbitrarily chosen and could have other values. Accordingly, the listed values of TDPM are first and foremost defined for the purpose of illustrating the present invention.

In the present description and in the appended claims the term “situation of water consumption” shall be construed to mean a situation in which water is deliberately being consumed, such as by deliberately opening a tap for letting water run.

In one embodiment of the leak detection system according to the present invention, the value A of flow of water is selected from the ranges 125-230 TDPM, such as 130-220 TDPM, e.g. 140-210 TDPM, such as 150-200 TDPM, for example 160-190 TDPM, such as 170-180 TDPM;

and/or
the value B of flow of water is selected from the ranges 1-10 TDPM, such as 2-9 TDPM, for example 3-8 TDPM, such as 4-7 TDPM or 5-6 TDPM.

In one embodiment of the leak detection system according to the present invention, the leak detection system further comprises communication means for communicating to an individual, information indicating that a leak is present in said water installation and/or information indicating that no leak is present in said water installation, based on the magnitude of said leak value LV.

In one embodiment of the leak detection system according to the present invention said communication means is a visual communication means, such as a display or a lighting element providing a lighting signal and/or said communication means is an audible communication producing a sound signal.

In one embodiment of the leak detection system according to the present invention said communication means is configured to communicate a qualitative indication, indicating presence of a leak in said water installation, but not the magnitude of said leak.

In one embodiment of the leak detection system according to the present invention said communication means is configured to communicate a quantitative indication, indicating presence of a leak as well as the magnitude of the leak, based on the magnitude of leak value LV.

Providing the leak detection system with such communication means allows a user to be warned in case a situation appears which could indicate the onset of a leak situation.

In one embodiment of the leak detection system according to the present invention said communication means is configured to communicate said quantitative indication, wherein said quantitative indication is graduated between three, or four or more graduations, such as between the following graduations:

$$“ no leak situation ” = tap drops per minute ( TDPM ) of [ 0 - 4 ] ;$$

$$“ micro leak situation ” = TDPM of ] 4 - 18 [ ;$$

$$“ small leak situation ” = TDPM of [ 18 - 180 ] ;$$

$$“ situation of water consumption ” = TDPM of > 180.$$

In these ranges the magnitude of 180 tap drops per minute (TDPM) corresponds to the value A as defined in respect of the leak detection system of the first aspect of the invention; the magnitude of [0-4] tap drops per minute (TDPM) corresponds to the value B as defined in respect of the leak detection system of the first aspect of the invention, and the magnitude of ]4-18[ and/or [18-180] tap drops per minute (TDPM) corresponds to the value C as defined in respect of the leak detection system of the first aspect of the invention.

Such graduation accordingly will quantify the magnitude of a detected leak and hence indicates the severity or progression of a leak situation in a water installation.

In one embodiment of the leak detection system according to the present invention the heating element HE is configured to dissipate a power per inner cross-sectional area of said pipe P of 0.1-5 W/cm², such as 0.2-4 W/cm², for example 0.4-3 W/cm², e.g. 0.5-2 W/cm², for example 0.75-1 W/cm²; and/or wherein said heating element HE is configured to dissipate a power of 0.1-10 W, such as 0.2-8 W, for example 0.4-7 W, such as 0.5-6 W, for example 0.75-5 W, such as 1-4 W or 2-3 W.

Such magnitudes of dissipated powers by the heating element have proved adequate for pipes used in most water installation for private houses.

In one embodiment of the leak detection system according to the present invention the first predetermined threshold temperature TT1 is selected from the ranges of 0.1-5° C., such as 0.2-4.9° C., for example 0.3-4.8° C., such as 0.4-4.7° C., for example 0.5-4.6° C., such as 0.6-4.5° C., e.g. 0.7-4.4° C., for example 0.8-4.3° C. or 0.9-4.2° C., such as 1.0-4.1° C., such as 1.1-4.0° C., for example 1.2-3.9° C., such as 1.3-3.8° C., for example 1.4-3.7° C., such as 1.5-3.6° C., e.g. 1.6-3.5° C., for example 1.7-3.4° C. or 1.8-3.3° C., such as 1.9-3.2° C., for example 2.0-3.1° C., e.g. 2.1-3.0° C., for example 2.2-2.9° C., such as 2.3-2.8° C., for example 2.4-2.7° C., such as 2.5-2.6° C.;
and/or
said second predetermined threshold temperature TT2 is selected from the ranges of TT1+a constant, wherein said constant is selected from the ranges of 0.1-5° C., such as 0.2-4.9° C., for example 0.3-4.8° C., such as 0.4-4.7° C., for example 0.5-4.6° C., such as 0.6-4.5° C., e.g. 0.7-4.4° C., for example 0.8-4.3° C. or 0.9-4.2° C., such as 1.0-4.1° C., such as 1.1-4.0° C. for example 1.2-3.9° C., such as 1.3-3.8° C., for example 1.4-3.7° C., such as 1.5-3.6° C., e.g. 1.6-3.5° C., for example 1.7-3.4° C. or 1.8-3.3° C., such as 1.9-3.2° C., for example 2.0-3.1° C., e.g. 2.1-3.0° C., for example 2.2-2.9° C., such as 2.3-2.8° C., for example 2.4-2.7° C., such as 2.5-2.6° C.

The above stated magnitudes of the threshold temperatures TT1 and TT2, respectively have proven adequate for pipes used in most water installation for private houses.

In one embodiment of the leak detection system according to the present invention the first temperature sensor TS1, said second temperature sensor TS2 and said heating element HE are configured to be arranged on said surface of said pipe P in an in-line-configuration.

Hereby, an optimum sensitivity of the sensing ability of the leak detection system is achieved.

In one embodiment of the leak detection system according to the present invention the first temperature sensor TS1, said second temperature sensor TS2 and said heating element HE are configured to be arranged on an inner or on an outer surface of said pipe P.

In one embodiment of the leak detection system according to the present invention the first temperature sensor TS1, said second temperature sensor TS2 and said heating element HE are configured to be arranged on said surface of said pipe P in such a way that in relation to an intended flow direction of water in said pipe, said second temperature sensor TS2 is configured to be arranged on said pipe at a position upstream in relation to said heating element HE, and is configured to be arranged on said pipe at a position downstream in relation to said first temperature sensor TS1.

This arrangement of the two temperature sensors TS1 and TS2 and the heating element implies a relative high sensitivity of the leak detection system.

In one embodiment of the leak detection system according to the present invention the first temperature sensor TS1, said second temperature sensor TS2 and said heating element HE are independently configured to be arranged on said surface of said pipe P at a mutual axial distance independently selected from the ranges of 10-300 mm, such as 15-250 mm, such as 20-200 mm, for example 25-150 mm, such as 40-130 mm, e.g. 50-120 mm, for example 60-110 mm, such as 70-100 mm or 80-90 mm.

These distances provide for adequate measuring differences of temperatures of the water being present in the pipe.

In one embodiment of the leak detection system according to the present invention the heating element HE is being an electric heating element, and said leak detection system further comprises a power supply for supplying a voltage to said heating element.

In one embodiment of the leak detection system according to the present invention the control unit CU is configured to supply said voltage to said heating element HE.

Providing the heating element as an electric heating element provides for easy and cost-efficient set-up and operation of the system.

In one embodiment of the leak detection system according to the present invention the control unit CU is configured to only determine that a situation of no water consumption is being present in respect of said water installation, in case said leak value LV is above said first predetermined threshold temperature TT1 over a time span of 0.5-15 min or more, such as 1-14 min, e.g. 2-13 min, such as 3-12 min, for example 4-11 min, such as 5-10 min, for example 6-9 min or 7-8 min; and/or
the control unit CU is configured to only determine that a situation of no leak is being present in respect of said water installation, in case said leak value LV is above said second predetermined threshold temperature TT2 over a time span of 0.5-15 min or more, such as 1-14 min, e.g. 2-13 min, such as 3-12 min, for example 4-11 min, such as 5-10 min, for example 6-9 min or 7-8 min; and/or
the control unit CU is configured to only determine that a situation of leak is being present in respect of said water installation, in case said leak value LV is above said first predetermined threshold temperature TT1 and below said second predetermined threshold temperature TT2 over a time span of 0.5-15 min or more, such as 1-14 min, e.g. 2-13 min, such as 3-12 min, for example 4-11 min, such as 5-10 min, for example 6-9 min or 7-8 min.

By making sure that the leak value LV is having a value in relation to the first and the second threshold temperature TT1 and TT2, respectively, over such a predetermined time span, it is to a higher degree avoided that false detections of a leak situation will happen due to minor fluctuations or unstable temperatures measured.

In one embodiment of the leak detection system according to the present invention the control unit CU is configured to only determine the magnitude of said leak value LV in a situation, wherein the measured temperatures are measured in a steady-state temperature situation in relation to T1 and T2.

Likewise, by making sure that the temperatures T1 and T2, as measured by the temperature sensors, TS1 and TS2, respectively, is in a steady-state situation, before the leak value LV is determined, it will to a higher degree be avoided that false detections of a leak situation will happen due to minor fluctuations or unstable temperatures measured.

In one embodiment of the leak detection system according to the present invention the control unit CU is configured to only determine the magnitude of said leak value LV in a situation, wherein the power supplied to said heating element HE is being constant over time.

The leak detection system of the present invention is generally based on the principle of supplying a heating power to the water pipe, which is constant over time.

In one embodiment of the leak detection system according to the present invention the leak detection system is for detecting a leak in a cold-water installation or in a hot-water installation.

In one embodiment of the leak detection system according to the present invention the leak value LV is defined as the difference T2−T1, and the control unit CU is configured to determine and log said leak value LV.

This embodiment provides for a very simple operation, wherein the leak value is directly obtainable from the two temperatures T1 and T2, as measured by the two temperature sensors TS1 and TS2, respectively.

In one embodiment of the leak detection system according to the present invention the leak value LV is defined as the difference T2−TH; wherein TH is defined as the lower limit of the temperature T2 which can be attained in a situation of no leak; and the control unit CU is configured to determine and log said leak value LV.

This embodiment requires a more complicated operation. However, this embodiment provides for higher sensitivity as to the determined leak value LV.

In one embodiment of the leak detection system according to the present invention the leak detection system further comprises a third temperature sensor TS3 configured to provide a third signal representative of a third temperature T3, measured by said third temperature sensor TS3; wherein said third temperature sensor TS3 is configured to be arranged at a distance from said pipe P in order to measure the temperature T3 of the ambient air of said pipe; wherein said third temperature sensor TS3 is configured to communicate said third signal to said control unit, thereby making said control unit CU register said third temperature T3;
wherein said control unit CU is configured to repeatedly log the value of said third temperature T3;
wherein said control unit CU is configured to apply said third temperature T3 as input in a calculation of said leak value LV, according to a predetermined calculation method;
wherein TH is being approximated as:

$$TH = ( T 3 - TL / K 1 + K 2 ;$$

wherein TL is being defined as the temperature T1 of the inlet water flowing into said pipe as measured by TS1 in a situation of water consumption;
wherein K1 is a system dependent parameter, being found from the above formula in a no leak situation;
wherein K2 is being a user selected sensitivity parameter.

This embodiment allows determination, by calculation, of the leak value LV, based on temperatures T1, T2 and T3, respectively, as measured by temperature sensors TS1, TS2 and TS3, respectively, under different leak situations.

In one embodiment of the leak detection system according to the present invention, the leak detection system further comprises one or more moist detectors, wherein each said moist detector is configured to detect moist and in a situation of moist detection is configured to communicate to said control unit CU that moist is detected, and wherein said control unit CU is configured to communicate to an individual, information that moist has been detected.

The moist detector may suitably be arranged under appliances using water, such as a dishwasher or a washing machine. Thereby the control unit may be capable of detecting a leak originating from leaked water from such a machine.

In one embodiment of the leak detection system according to the present invention, the transmission of signals between said control unit and one or more of said first temperature sensor TS1, said second temperature sensor TS2, said third temperature sensor TS3, if being present, and said moist detector, if being present, independently are configured to be conveyed by wire or wirelessly.

Depending on the actual set-up, both transmission by wire or wirelessly may have its advantages.

In one embodiment of the leak detection system according to the present invention the leak detection system further comprises a thermally insulating material which is being wrapped around said pipe segment, said first temperature sensor TS1, said second temperature sensor TS2 and said heating element HE.

Hereby any impact on the temperatures T1 and T2 as measured by temperature sensors TS1 and TS2 from the surroundings may be reduced.

In one embodiment of the leak detection system according to the present invention the leak detection system further comprising a flow meter for measuring the magnitude of flow in said pipe segment, wherein said flowmeter is configured to be able to communicate a measured flow to said control unit (CU); and/or further comprising an on/off valve (V1), which is optionally configured to be in communication with said control unit (CU), thereby allowing said control unit to turn on/off said valve; and/or further comprising a liquid pressure sensor for measuring the pressure of the liquid flowing in said pipe segment, wherein said liquid pressure sensor optionally is configured to be able to communicate a measured pressure to said control unit (CU), wherein said liquid pressure sensor optionally is being arranged on said pipe segment downstream in relation to said valve (V1).

Hereby, improved controlling of the leak detection system is provided.

In a second aspect the present invention provides a use of a leak detection system according the first aspect of the invention for detecting a leak in a water installation.

In a third aspect the present invention relates to a water installation comprising a leak detection system according the first aspect of the invention.

In one embodiment of the water installation according to the present invention said water installation is a water installation for distributing water for consumption.

In a fourth aspect the present invention relates to a structure comprising a water installation according to the third aspect of the invention.

In one embodiment of the structure according to the present invention, the structure is being a building, such as a house.

In a fifth aspect the present invention provides a method for detecting a leak in a water installation; said method comprising the steps of:
i) supplying power to a heating element HE arranged at a position on the surface of a pipe P of said water installation;
ii) measuring a first temperature T1 of water flowing in said pipe at a location upstream of said heating element in relation to flow direction of the water flowing in said pipe;
iii) measuring a second temperature T2 of water flowing in said pipe at a location between the position of said heating element and the position of measuring said first temperature T1;
iv) optionally measuring a third temperature T3 corresponding the temperature of the air surrounding the pipe P;
v) repeatedly calculation of a leak value LV, according to a predetermined calculation method, wherein the magnitude of said leak value LV is being indicative of the presence of a leak and optionally also the magnitude of such a leak in said water installation; wherein the temperatures T1 and T2, and optionally also the temperature T3 are used as input in said calculation method;
vi) determine that a situation of no water consumption is present in case said leak value LV is above a first predetermined threshold temperature TT1;
vii) determine, in a situation of no water consumption, as determined in step vi), that no leak is present in case LV is above a second predetermined threshold temperature TT2; or detect that a leak is present in case LV is above said first predetermined threshold temperature TT1 and below said second predetermined threshold temperature TT2; wherein TT2>TT1.

In one embodiment of the method according to the present invention the leak value LV as determined in step v) is calculated as LV=T2−T1.

This embodiment provides for a very simple operation, wherein the leak value is directly obtainable from the two temperatures T1 and T2, as measured by the two temperature sensors TS1 and TS2, respectively.

In one embodiment of the method according to the present invention the leak value LV as determined in step v) is calculated as LV=T2−TH; wherein TH is being defined as the lower limit of the temperature T2 which can be attained in a situation of no leak.

In one embodiment of the method according to the present invention TH is being approximated as:

$$TH = ( T 3 - TL / K 1 + K 2 ;$$

wherein TL is being defined as the temperature T1 of the inlet water flowing into said pipe as measured by TS1 in a situation of water consumption;
wherein K1 is system dependent parameter, being found from the above formula in a no leak situation;
wherein K2 is being a user selected sensitivity parameter.

These two embodiments require a more complicated operation. However, this embodiment provides for higher sensitivity as to the determined leak value LV.

It should be specifically noted that features and embodiments relating to the leak detection system of the first aspect of the present invention may apply in an analog way to embodiments of the method of the fifth aspect of the present invention.

In one embodiment of the method according to the present invention the method involves using of a leak detection system according to the first aspect of the present invention.

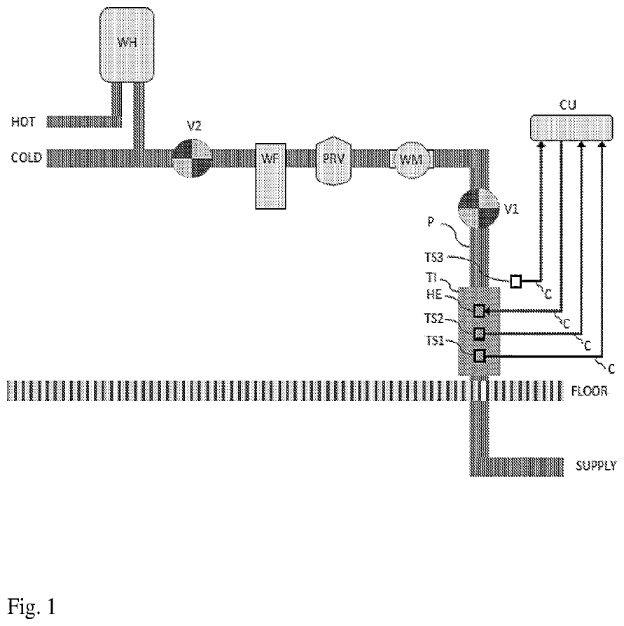

Referring now to the figures for better illustrating the present invention, FIG. 1 is a schematic diagram depicting an example of a setup for using the leak detection system according to the first aspect of the present invention in a water installation.

FIG. 1 shows a typical water plumbing system in a water installation in a building. Cold water is entering from a main water pipe SUPPLY below terrain, through the ground deck FLOOR.

Onto the outer surface of the pipe P and in order of direction of water streaming in the pipe from below, the following items are arranged: a first temperature sensor TS1, a second temperature sensor TS2 and a heating element HE. TS1, TS2 and HE are surrounded with a thermal insulation T1. A few centimeters from the pipe P a third temperature sensor TS3 is arranged, thus measuring the temperature of the ambient air.

TS1, TS2. TS3 and HE are communicating with a control unit CU via communication lines C. In this way, the control unit CU provides voltage to the heating element HE in order to dissipate power in that heating element. Also, electric signals from the first, the second and the third temperature sensors TS1, TS2 and TS3, respectively, which represent measured temperatures T1, T2 and T3, respectively are sent to the control unit CU, where they are logged and processed.

The components TS1, TS2, TS3, HE and CU are together working as a leak detecting system as explained in further details below.

Valve V1 is a main valve which can be manually controlled or electrically controlled by control unit CU. WM is water meter measuring the magnitude of flow through it. Further downstream are arranged optional equipment in the form of a pressure reduction valve PRV, water filter WF and a manually operated valve V2.

Valve V2 is installed for use when doing service and maintenance of any of the equipment between valves V1 and V2. Downstream of V2 the pipe P splits up in two branches, one goes to the water heater WH and exits WH as a hot waterpipe HOT. The other branch continues as cold waterpipe COLD to different tap locations in the building wherein the water installation is installed.

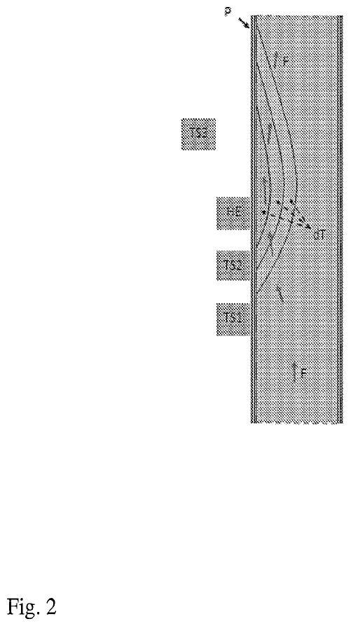

FIG. 2 is a schematical drawing illustrating the impact on the temperature of the water flowing in the pipe P due to the presence of the heating element HE in a situation where the pipe P is vertically arranged.

Temperature sensor TS1 measures the water temperature T1 nearest to the water inlet, Temperature TS2 measures the water temperature T2 a little above TS1, and heat element HE is mounted on the pipe a little over TS2. The temperature sensors TS1 and TS2 and the heating element HE are positioned in an in-line configuration. TS3 is measuring the ambient air temperature and is located so that it is not influenced by the heat from HE and P.

The heat dissipated in HE will generate a temperature increase dT in the water in case no or only a small water flow F is present.

It is seen that due to the small water flow F through the pipe P, and also due to the vertical arrangement of the pipe P, the propagation of heat originating from heating element HE is not symmetrical in relation to areas above and below the heating element HE.

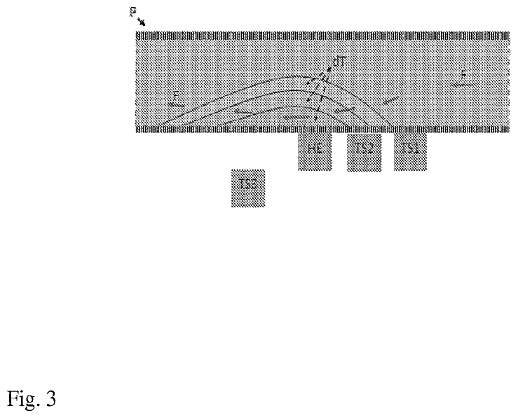

FIG. 3 illustrates the heat distribution of the water in a pipe set up as in FIG. 2, this time however, the pipe P is horizontally arranged and the temperature sensors TS1 and TS2 and the heating element HE are connected on the bottom outer surface of the pipe P in order to achieve the best micro-leak sensitivity.

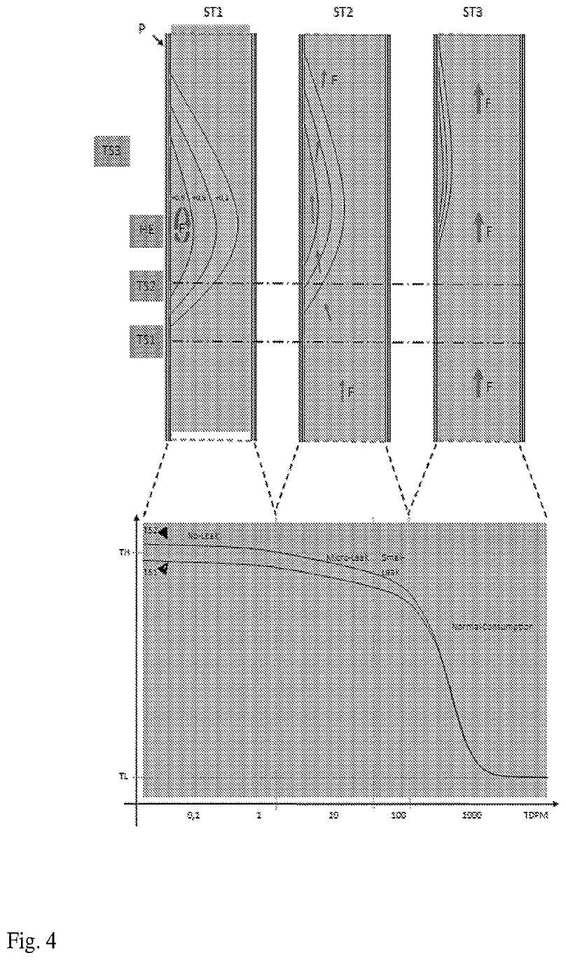

FIG. 4 is a schematic diagram illustrating the heat distribution in the water flowing in the cold water pipe under different magnitudes of flow F in the pipe P and caused by the presence of the heating element HE.

FIG. 4 shows four situations of magnitudes of water flows in the pipe, ranging from a “no-leak” situation (left) over a “micro leak” situation and a “small leak” situation (middle) and to a situation of water consumption in the pipe P (right).

Upper part of FIG. 4 illustrates the pipe with the two temperature sensors TS1, TS2 and the heating element HE arranged on the pipe P and also shows the temperature sensor TS3 arranged near, yet separated from the pipe P. Upper part of FIG. 4 also illustrates the heat distribution in the water in the pipe P which is caused by the heating element HE, as illustrated by the shaded areas.

Lower part of FIG. 4 illustrates the temperature T1 (lower curve) and T2 (upper curve) as measured by the temperature sensors TS1 and TS2, respectively, in the flow situations (from left to right) of “no leak”, “micro leak”, “small leak” and “normal consumption”.

TH is defined as the lower limit of the temperature T2, as measured by temperature sensor TS2, which can be attained in a situation of no leak.

TL is defined as the inlet temperature (as measured by TS1) in a situation of water consumption.

It should be noted that in a typical family house, the water is turned on and off many times in the morning and in the evening, but during the day and especially during the night normally there will be long periods without water consumption. After a relatively long pause in the water consumption, the system enters into a no-leak situation, where the temperature in the pipe P is stabilized. Subsequently, when a water flow F again is present in the pipe P, the temperature in P at the position of temperature sensors TS1 and TS2 will start to decrease depending on the magnitude of water flow F.

In the left hand side of FIG. 4 we have a “no leak” situation, wherein F<1 TDPM. Here, TS2 is above TH and TS2−TS1=1° C.

When the flow of water F in pipe P changes from 0 to 10 TDPM then TS1 and TS2 will slowly start to decrease. After an hour, TS2 decreases to just below TH, and a leak is detected as a “micro leak”.

In case the flow F in pipe P is further increased to 100 TDPM, then in a few minutes TS2 will decrease to clearly below TH, and a leak can be detected as a “small leak”. At the same time TS2-TS1 will decrease to below 0.5° C.

In case the flow F in pipe P is further increased to more than 200 TDPM, then TS2-TS1 will decrease to below 0.3° C. and T1 measured by TS1 will decrease to a value corresponding to the TL value. In this case we have a situation of water consumption.

Overall, it can be seen in FIG. 4, especially from the lower part of FIG. 4, that a leak value LV defined as either LV=T2−1 or as LV=T2−TH can be introduced as an indicator of the magnitude of water F flowing in the pipe P, where the temperatures T1, T2 and optionally also T3 as measured by the temperature sensors TS1, TS2 and TS3 can be applied as input for determining LV.

TH may be found empirically, or it may be calculated as:

$$TH = TS 3 - ( TS 3 - TL ) / K 1 + K 2.$$

wherein K1 is a system specific constant and K2 is a user selected sensitivity parameter.

The above formula is further explained in Working Example 2 below.

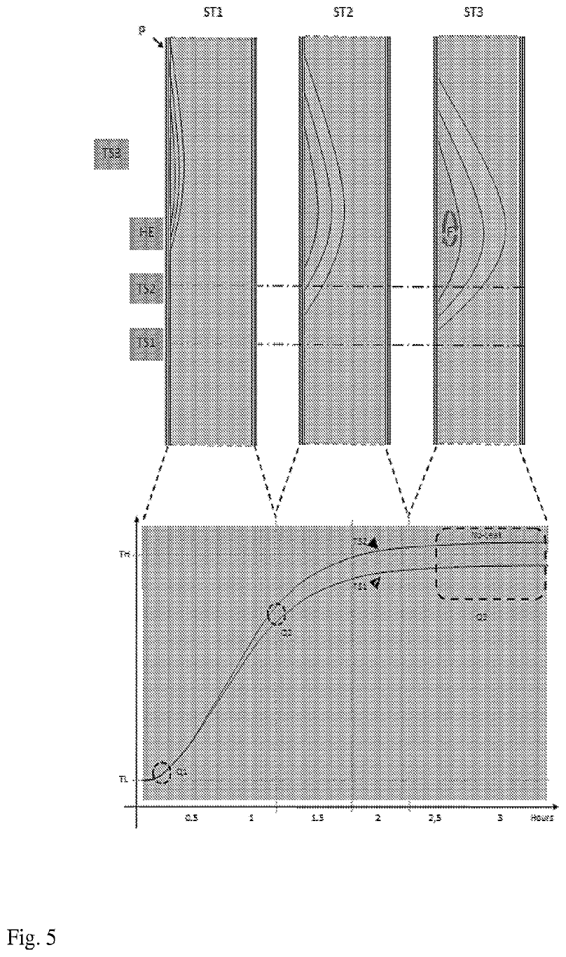

FIG. 5 is a schematic diagram illustrating the development over time of the water temperature of water being present in the pipe P in a no-leak situation, beginning just after ending a situation of water consumption.

FIG. 5 shows that over time, just after ending a situation of water consumption, the temperature of T1 as measured by temperature sensor TS1 and the temperature T2 as measured by temperature sensor TS2 increase.

At time corresponding to Q1, T1>TL+0.3° C., which indicates that the flow of water due to water consumption has stopped. At time corresponding to Q2, T2−T1 has passed 0.5° C.

The time span between Q1 and Q2 may be used to calculate a minimum required time span after which, it with a high degree of reliability, can be concluded that a “small leak” situation may be present.

At time corresponding to Q3, T2>TH and T2−T1=1° C. This situation thus represents a “no-leak” situation.

The time span between Q1 and Q3 may be used to calculate a minimum required time span after which, it with a high degree of reliability, can be concluded whether a “micro leak” situation or a “no leak” situation may be present.

In case a “no leak” situation has been detected and in case the flow of water F changes to “micro-leak” level, then T2 and T1 will start to decrease and over time T2 will get below TH, which indicates a “micro-leak” level. Similarly, in case the flow F of water is further increased to a “small leak” level, the temperatures T2 and T1 will end up indicating a “small leak” level.

The changing indication of situations of “no leak”, “micro leak” and “small leak” accordingly has built-in hysteresis.

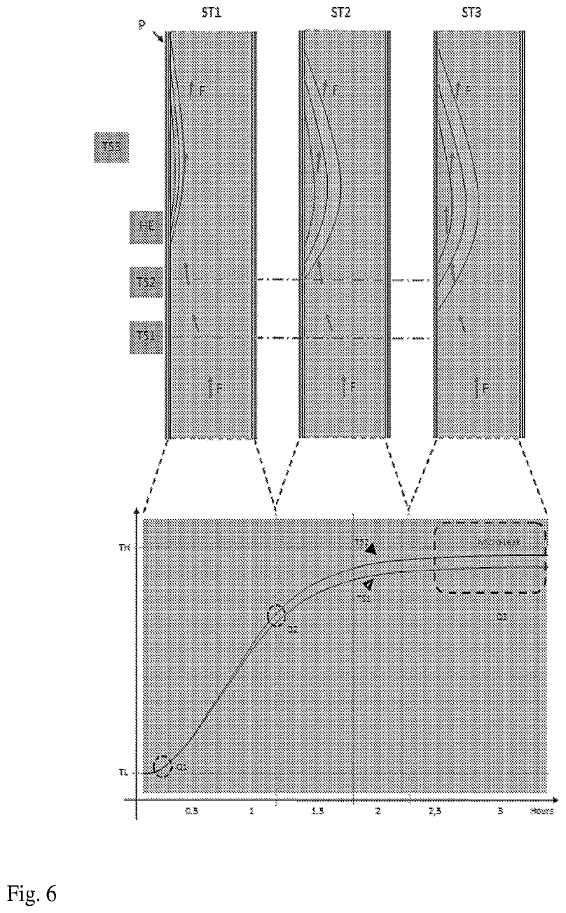

FIG. 6 is a schematic diagram illustrating the development over time of the water temperature of water being present in the pipe in a “micro leak” situation, beginning just after ending a situation of water consumption.

Accordingly, FIG. 6 is similar to FIG. 5, this time however, the time span shown ends in a situation of “micro leak”, rather than “no leak”.

At time corresponding to Q1, T1>TL+0.3° C., which indicates that the flow of water due to water consumption has stopped.

At time corresponding to Q2, T2−T1 has passed 0.5° C. which indicates that either a “micro leak” or no leak is present.

At time corresponding to Q3, T2−T1 is in the range of 0.5-1.0° C. and the magnitude of the difference T2−TH indicates that a “micro leak” is present.

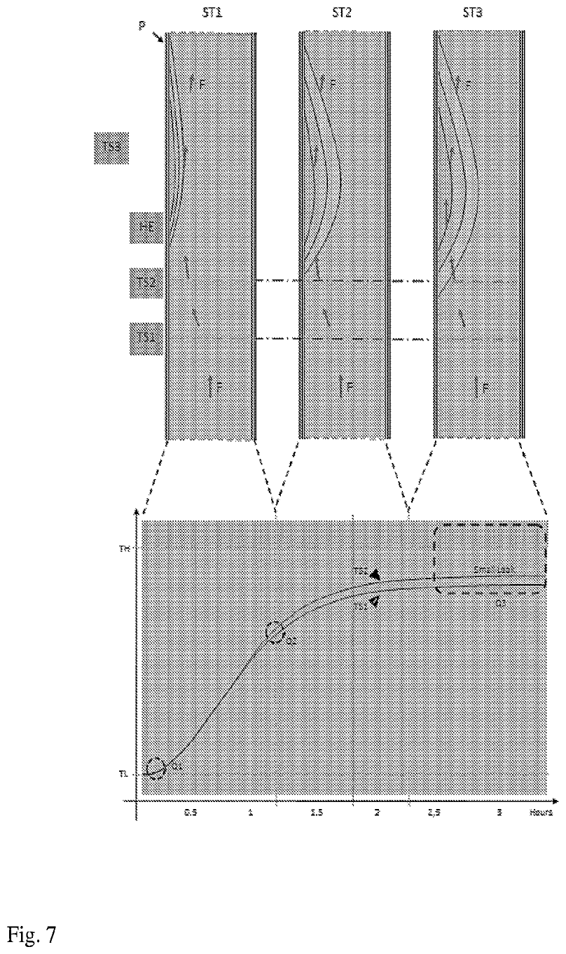

FIG. 7 is a schematic diagram illustrating the development over time of the water temperature of water being present in the pipe in a “small leak” situation, beginning just after ending a situation of water consumption.

Accordingly, FIG. 7 is similar to FIGS. 5 and 6, this time however, the time span shown ends in a situation of “small leak”, rather than “no leak” or “micro leak”.

At time corresponding to Q1, T1>TL+0.3° C., which indicates that the flow of water due to water consumption has stopped.

At time corresponding to Q2, T2−T1 is still below 0.5° C. which indicates that a “small leak” is present.

At time corresponding to Q3, T2−T1 is still below 0.5° C. and the magnitude of the difference T2−TH indicates that a “small leak” is present.

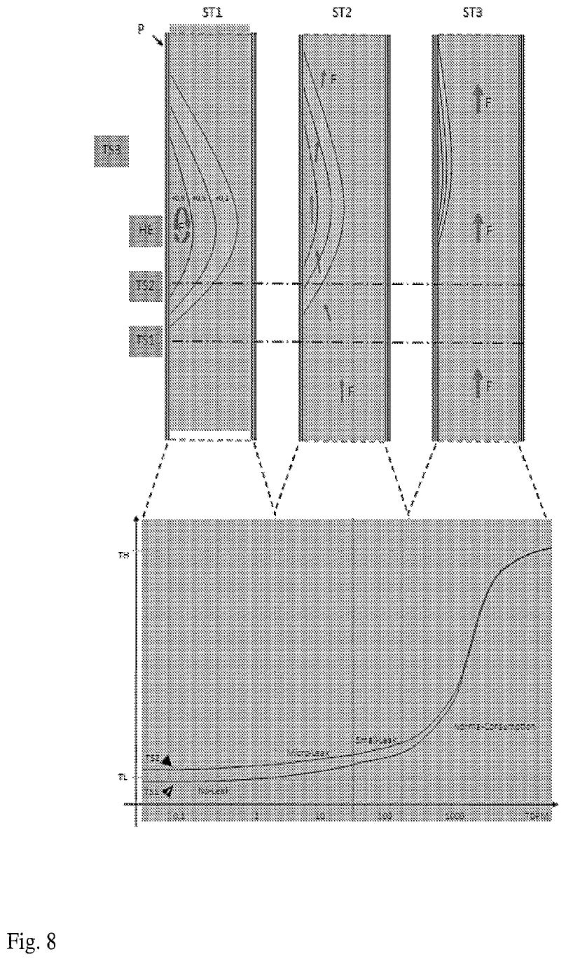

FIG. 8 is a schematic diagram illustrating the heat distribution in the water flowing in a hot water pipe under different magnitudes of flow F in the pipe P and caused by the presence of the heating element HE.

FIG. 8 shows the increasing T1 and T2 depending on the flow F expressed in TDPM, when the sensors TS1 and TS2 and the heating element HE are mounted on a hot-water pipe.

This diagram basically reflects the same situation as in the case where the temperature sensors and the heating element were mounted on a cold-water pipe, with the exception that the temperatures T1 and T2 increases instead of decreases when water flow F is allowed to flow in the pipe.

Based on T1 and T3 the system may be able to sense whether it is dealing with a cold or hot water pipe P.

### Working Example 1

The following example illustrates a specific example of using a leak detection system according to the present invention for detecting a leak in a water installation in a family house.

This example illustrates using the value of the difference of the temperatures T2 and T1, as measured by temperature sensor TS2 and TS1, respectively, to determine presence of a leak in a water installation.

### Hardware Setup

The water installation employed in this example comprises a 1″ inlet steel pipe for cold water consumption entering through a basement floor.

On this this steel pipe are attached by using tape sensor TS1 and sensor TS2.

Sensors TS1 and TS2 are of the same type (Zigza available on the website www.zigza.dk).

A heating element HE, comprising a resistor having a resistance of 144 ohm and being protected by heat shrink tube is attached by tape to the steel pipe. The resistor is supplied with a voltage of 12 V, thereby dissipating a constant power of 1 W in the heating element HE.

The sensors TS1 and TS2 and the heating element HE are arranged on the steel pipe in an in-line configuration in such a way that the order of arrangement on the steel pipe (from below and upwards) of the two sensors and the heating element is: temperature sensor TS1, temperature sensor TS2, heating element HE, and in such a way that temperature sensor TS1 is arranged 20 cm above floor level, temperature sensor TS2 is arranged 5 cm above temperature sensor TS1 and heating element HE is arranged 5 cm above temperature sensor TS2.

The temperature sensor TS1 and the temperature sensor TS2 are connected to a control unit of the type IHC system, available on the website www.lk.dk. IHC (In House Concept) is a control system for homes, institutions and smaller companies, to manage electrical installations like alarm installation and heating control. The system can be programmed to monitor all kinds of input and take all kinds of actions to control outputs.

The area of the steel pipe comprising the temperature sensor TS1, the temperature sensor TS2 and the heating element HE is thermally insulated from the surroundings by a thermally insulating foam wrap of the type Armaflex from floor level and 40 cm up.

### Experimental Results

Using the above setup, the hardware is subjected to various leak conditions. These various leak conditions are selected by making sure that no leak at all is present in the water installation and subsequently by simulating that a leak is present by means of deliberately letting a water tap of the water installation drip at different magnitudes of TDPMs as show in in the table below.

At each setting of the various leak simulations, the temperature T1 as measured by TS1 and the temperature T2 as measured by TS2 are logged by the control system and after stabilization of the temperature, the data of Table 1 is collected/calculated as shown below.

TABLE 1

| | Normal- | | Micro- | Small- |
|---|---|---|---|---|
| Data name | Consumption | No-Leak | Leak | Leak |
| Magnitude of | >50 | <0.5 | 2 ml/min | 15 |
| flow of water in | ml/min | ml/min | (8 TDPM) | ml/min |
| pipe | | | | (60 |
| | | | | TDPM) |
| T1 | 8.5° C. | 16.9° C. | 16.0° C. | 14.4° C. |
| T2 | 8.5° C. | 17.8° C. | 16.7° C. | 14.8° C. |
| LV = T2 − T1 | 0° C. | 1.0° C. | 0.7° C. | 0.4° C. |

The results in table 1 shows that in a situation of water consumption (second column) the difference between measured T1 and T2 by temperature sensor TS1 and TS2, respectively reduces to zero.

Table 1 also shows that, as the magnitude of the leak decreases (column 5, 4 and 3), the difference LV=T2−T1 becomes larger.

Accordingly, measuring the temperatures T1 and T2 by the sensors TS1 and TS2, respectively, of the water installation, allows one to assess whether or not the water installation delivers water for consumption or not. And it also allows for determining, in a situation of no water consumption but with a leak, the magnitude of the leak, depending on the magnitude of the difference LV=T2−T1.

The difference LV=T2−T1 accordingly can be used for defining the threshold temperatures TT1 and TT2, which define the borderline between water flow due to consumption of water and water flow due to leak on the one hand, and borderline between water flow due to leak and no leak on the other hand.

The value of LV at different leak/no leak/consumption situations may accordingly be fed to a data storage in the control unit with the view that the control unit subsequently will be able to detect and communicate to a user when a leak situation is present, based on the difference T2−T1.

### Working Example 2

The following example illustrates another specific example of using a leak detection system according to the present invention for detecting a leak in a water installation in a family house.

This example illustrates using the value of the difference of the temperatures T2 and TH for detection of presence of a leak in a water installation. TH is defined as the lower limit of the temperature T2, as measured by temperature sensor TS2, which can be attained in a situation of no leak in the water installation.

Accordingly, the difference between the temperature T2 and the temperature TH expresses whether the water installation delivers water for water consumption or not. And furthermore, in a situation of no water consumption, the magnitude of the difference between the temperature T2 and the temperature TH also expresses the magnitude of a leak, if present.

### Hardware Setup

The same hardware setup as in Working Example 1 is used.

However, in this example, additionally also a third temperature sensor TS3 is used.

The third sensor TS3 is arranged in free air at a distance of 30 mm from the steel pipe for detecting the room temperature in vicinity to the pipe. Sensor TS3 is of the same type as sensors TS1 and TS2.

Also, temperature sensor TS3 is connected to the control unit.

### Experimental Results

Using the above setup, the hardware was subjected to the leak conditions as shown in Table 2 below.

Again, at each setting of the various leak simulations, the temperature T1 as measured by TS1, the temperature T2 as measured by TS2 and the temperature T3 as measured by TS3 were logged by the control unit and after stabilization of the temperature, the data of Table was collected and calculated:

TABLE 2

| | | | | |
|---|---|---|---|---|
| | Normal- | | | |
| Data name | Consumption | No-Leak | Micro-Leak | Small-Leak |

Measured values

| | | | | |
|---|---|---|---|---|
| Magnitude of | >50 ml/min | <0.5 | 1.2 ml/min | 13 ml/min |
| flow of water in | | ml/min | (5 TDPM) | (55 TDPM) |
| pipe | | | | |
| T1 | 8.3° C. | 16.7° C. | 16.2° C. | 14.6° C. |
| T2 | 8.3° C. | 17.6° C. | 16.9° C. | 15.0° C. |
| T3 | 20.7° C. | 20.7° C. | 20.7° C. | 20.7° C. |
| TL | 8.3° C. | 8.3° C. | 8.3° C. | 8.3° C. |

Calculated values

| | | | | |
|---|---|---|---|---|
| T1-TL | 0° C | 8.4° C. | 7.9° C. | 6.3° C. |
| TH | 17.6° C. | 17.6° C. | 17.6° C. | 17.6° C. |
| LV = T2 − TH | −9.3° C. | 0.0° C. | −0.7° C. | −2.6° C. |
| LV′ = LV + K3 | −8.8° C. | 0.5° C. | −0.2° C. | −2.1° C. |

In this example we illustrate that the magnitude of the difference T2−TH can be used to determine whether or not a leak is present and also, in case a leak is present, to assess the magnitude of this leak.

We define TH as the lowest value the temperature T2 can have in a no leak situation.

TH is approximated by the formula TH=TS3−(TS3−TL)/K1+K2.

In this formula, K2 is a user selected sensitivity parameter. For simplicity, in this example we set the sensitivity parameter K2 to be equal to zero.

Per definition, in a no leak situation, TH is equal to T2. This allows us to calculate the system specific constant K1 from the formula:

$$TH = T 2 = T 3 - ( T 3 - TL ) / K 1 ( in a no leak situation ) \text{=>}$$

$$K 1 = ( T 3 - TL ) / ( T 3 - T 2 ) ( in a no leak situation ) .$$

From column 3 in Table 2 above (relating to a no leak situation), we find that:

$$K 1 = 20.7 ° C . - 8.3 ° C . / ( 20.7 ° C . - 17.6 ° C . ) = 4. .$$

Knowing K1 and using the general formula TH=T3−(T3−TL)/K1+K2, the values of TH in the different leak situations is subsequently used to calculate the leak value, LV=T2−TH in respect of the different leak/no-leak situations as shown in Table 2 above.

In order to introduce a tolerance in respect of the leak value LV, based on which the control unit is configured to communicate an alarm to a user in case a leak is detected, a derived leak value, LV′ is introduced so as to avoid alarms in case only very small leaks are detected.

The derived leak value LV′ is defined as follows:

$${LV}^{′} = LV + K 3.$$

In this working example we chose K3 to be 0.5° C.

Subsequently, the values of LV′ can be found as LV′=LV+K3 in respect of the remainder of the leak situations as shown.

It is seen in Table 2, that a LV-value of zero or below (corresponding to a derived leak value LV′ of 0.5 or below) means that a leak is present or that the water installation supplies water for consumption.

It is also seen in Table 2, that a LV-value of zero (or a LV′-value of 0.5) implies that no leak is present. In case the LV-value was above zero (0) (or the LV′-value was above 0.5), this situation would also imply that no leak is present.

It is noted that the Working example 2 is conducted without any variation in inlet temperature of the water (as expressed by T1 in a water consumption situation) and without any variation in the ambient temperature as expressed by T3.

Furthermore, it is noted, that instead of calculating TH according to the above approximated formula, TH may also be found from an empiric data set obtained by making measurement of T1, T2 and T3 at a variety of different combinations of temperatures. Subsequently, the TH found in such an empirical way may be used by the control unit CU in calculating the value of LV or LV′ with the view to detect leak in the same water installation.

The value of TH at different leak/no leak/consumption situations may accordingly be fed to a data storage in the control unit with the view that the control unit subsequently will be able to detect and communicate to a user when a leak situation is present, based on an actually measured difference LV=T2−TH, or LV′=LV+K3.

It should be understood that all features and achievements discussed above and in the appended claims in relation to one aspect of the present invention and embodiments thereof apply equally well to the other aspects of the present invention and embodiments thereof.

### LIST OF REFERENCE NUMERALS

WH Water heater
V1 Valve
V2 Valve
WF Water filter
PRV Pressure reduction valve
WM Water meter
P Pipe
TS1 Temperature sensor 1
TS2 Temperature sensor 2
TS3 Temperature sensor 3
HE Heating element
C Communication means
T1 Thermal insulation
CU Control unit
F Flow of water in pipe
dT Temperature gradient
TH Lower limit of temperature measured by TS2 in a no leak situation
TL Temperature of inlet water in a situation of water consumption

1. A leak detection system for a water installation comprising a leak detection device in combination with a pipe segment, wherein said leak detection device comprises:
a first temperature sensor (TS1) configured to provide a first signal representative of a first temperature T1 measured by said first temperature sensor;
a second temperature sensor (TS2) configured to provide a second signal representative of a second temperature T2 measured by said second temperature sensor;
a heating element (HE);
a control unit (CU);
wherein said first temperature sensor (TS1), said second temperature sensor (TS2) and said heating element (HE) are being mounted onto a surface of said pipe segment of a water pipe (P) for said water installation in such a way that in relation to an intended flow direction of water in said pipe segment, said second temperature sensor (TS2) is being arranged on said pipe segment at a position upstream in relation to said heating element, (HE) and is being arranged on said pipe segment at a position downstream in relation to said first temperature sensor (TS1);
wherein said first temperature sensor (TS1) is configured to communicate said first signal to said control unit (CU), thereby making said control unit (CU) register said first temperature T1;
wherein said second temperature sensor (TS2) is configured to communicate said second signal to said control unit (CU), thereby making said control unit (CU) register said second temperature T2;
wherein said control unit (CU) is configured to repeatedly log the value of said first temperature T1 and said second temperature T2;
wherein said control unit (CU) is configured to apply said first temperature T1 and said second temperature T2 as input in a calculation of a leak value LV, according to a predetermined calculation method;
wherein said control unit (CU) is configured to determine that a situation of no water consumption, as represented by a value A of flow of water of 240 TDPM (tap drops per minute) or less, is present in case LV is above a first predetermined threshold temperature TT1; and
wherein said control unit (CU), in such a situation of no water consumption, is configured to detect that no leak, as represented by a value B of flow of water of 10 TDPM or less, is present in case LV is above a second predetermined threshold temperature TT2; and wherein said control unit (CU), in such a situation of no water consumption, is configured to detect that a leak, as represented by a value C of flow of water of above the value B and below the value A, is present in case the leak value LV is above said first predetermined threshold temperature TT1 and below said second predetermined threshold temperature TT2;
wherein TT2>TT1;
wherein said leak value LV is defined as the difference T2−T1, and wherein said control unit (CU) is configured to determine and log said leak value LV.

2. A leak detection system according to claim 1, wherein the value A of flow of water is selected from the ranges 125-230 TDPM, such as 130-220 TDPM, e.g. 140-210 TDPM,
such as 150-200 TDPM, for example 160-190 TDPM, such as 170-180 TDPM;
and/or
wherein the value B of flow of water is selected from the ranges 1-10 TDPM, such as 2-9 TDPM, for example 3-8 TDPM, such as 4-7 TDPM or 5-6 TDPM.

3. A leak detection system according to claim 1 further comprising communication means for communicating to an individual, information indicating that a leak is present in said water installation and/or information indicating that no leak is present in said water installation, based on the magnitude of said leak value LV.

4. A leak detection system according to claim 3 wherein said communication means is a visual communication means, such as a display or a lighting element providing a lighting signal and/or wherein said communication means is an audible communication producing a sound signal.

5. A leak detection system according to claim 3, wherein said communication means is configured to communicate a qualitative indication, indicating presence of a leak in said water installation, but not the magnitude of said leak.

6. A leak detection system according to claim 3, wherein said communication means is configured to communicate a quantitative indication, indicating presence of a leak as well as the magnitude of the leak, based on the magnitude of leak value LV.

7. A leak detection system according to claim 6, wherein said communication means is configured to communicate said quantitative indication, wherein said quantitative indication is graduated between three, or four or more graduations, such as between the following graduations:
$$“ no leak situation ” = tap drops per minute ( TDPM ) of [ 0 - 4 ] ;$$
$$“ micro leak situation ” = TDPM of ] 4 - 18 [ ;$$
$$“ small leak situation ” = TDPM of [ 18 - 180 ] ;$$
$$“ situation of water consumption ” = TDPM of > 180.$$

8-9. (canceled)

10. A leak detection system according to claim 1, wherein said first temperature sensor (TS1), said second temperature sensor (TS2) and said heating element (HE) are arranged on said surface of said pipe (P) in an in-line-configuration.

11. A leak detection system according to claim 1, wherein said first temperature sensor (TS1), said second temperature sensor (TS2) and said heating element (HE) are arranged on an inner or on an outer surface of said pipe (P).

12. (canceled)

13. A leak detection system according to claim 1, wherein said first temperature sensor (TS1), said second temperature sensor (TS2) and said heating element (HE) are independently arranged on said surface of said pipe (P) at a mutual axial distance independently selected from the ranges of 10-300 mm, such as 15-250 mm, such as 20-200 mm, for example 25-150 mm, such as 40-130 mm, e.g. 50-120 mm, for example 60-110 mm, such as 70-100 mm or 80-90 mm.

14. A leak detection system according to claim 1, wherein said heating element (HE) is being an electric heating element, wherein said leak detection system further comprising a power supply for supplying a voltage to said heating element.

15. A leak detection system according to claim 14, wherein said control unit (CU) is configured to supply said voltage to said heating element (HE).

16-18. (canceled)

19. A leak detection system according to claim 1 for detecting a leak in a cold-water installation or in a hot-water installation.

20-22. (canceled)

23. A leak detection system according to claim 1 further comprising one or more moist detectors, wherein each said moist detector is configured to detect moist and in a situation of moist detection is configured to communicate to said control unit (CU) that moist is detected, and wherein said control unit (CU) is configured to communicate to an individual, information that moist has been detected.

24. (canceled)

25. A leak detection system according to claim 1 further comprising a thermally insulating material which is being wrapped around said pipe segment, said first temperature sensor (TS1), said second temperature sensor (TS2) and said heating element (HE).

26. A leak detection system according to claim 1 further comprising a flow meter for measuring the magnitude of flow in said pipe segment, wherein said flowmeter is configured to be able to communicate a measured flow to said control unit (CU); and/or further comprising an on/off valve (V1), which is optionally configured to be in communication with said control unit (CU), thereby allowing said control unit to turn on/off said valve; and/or further comprising a liquid pressure sensor for measuring the pressure of the liquid flowing in said pipe segment, wherein said liquid pressure sensor optionally is configured to be able to communicate a measured pressure to said control unit (CU), wherein said liquid pressure sensor optionally is being arranged on said pipe segment downstream in relation to said valve (V1).

27. (canceled)

28. A water installation comprising a leak detection system according to claim 1.

29. A water installation according to claim 28, wherein said water installation is a water installation for distributing water for consumption.

30-31. (canceled)

32. A method for detecting a leak in a water installation; said method comprising the steps of:
i) supplying power to a heating element (HE) arranged at a position on the surface of a pipe (P) of said water installation;
ii) measuring a first temperature T1 of water flowing in said pipe at a location upstream of said heating element in relation to flow direction of the water flowing in said pipe;
iii) measuring a second temperature T2 of water flowing in said pipe at a location between the position of said heating element and the position of measuring said first temperature T1;
iv) optionally measuring a third temperature T3 corresponding the temperature of the air surrounding the pipe (P);
v) repeatedly calculation of a leak value LV, according to a predetermined calculation method, wherein the magnitude of said leak value LV is being indicative of the presence of a leak and optionally also the magnitude of such a leak in said water installation; wherein the temperatures T1 and T2, and optionally also the temperature T3 are used as input in said calculation method;
vi) determine that a situation of no water consumption is present in case said leak value LV is above a first predetermined threshold temperature TT1;
vii) determine, in a situation of no water consumption, as determined in step vi), that no leak is present in case LV is above a second predetermined threshold temperature TT2; or detect that a leak is present in case LV is above said first predetermined threshold temperature TT1 and below said second predetermined threshold temperature TT2; wherein TT2>TT1;
wherein the leak value LV as determined in step v) is calculated as LV=T2−T1.

33. (canceled)

34-35. (canceled)

36. A method according to claim 19 using a leak detection system that includes:
a first temperature sensor (TS1) configured to provide a first signal representative of a first temperature T1 measured by said first temperature sensor;
a second temperature sensor (TS2) configured to provide a second signal representative of a second temperature T2 measured by said second temperature sensor;
a heating element (HE);
a control unit (CU);
wherein said first temperature sensor (TS1), said second temperature sensor (TS2) and said heating element (HE) are being mounted onto a surface of said pipe segment of a water pipe (P) for said water installation in such a way that in relation to an intended flow direction of water in said pipe segment, said second temperature sensor (TS2) is being arranged on said pipe segment at a position upstream in relation to said heating element, (HE) and is being arranged on said pipe segment at a position downstream in relation to said first temperature sensor (TS1);
wherein said first temperature sensor (TS1) is configured to communicate said first signal to said control unit (CU), thereby making said control unit (CU) register said first temperature T1;
wherein said second temperature sensor (TS2) is configured to communicate said second signal to said control unit (CU), thereby making said control unit (CU) register said second temperature T2;
wherein said control unit (CU) is configured to repeatedly log the value of said first temperature T1 and said second temperature T2;
wherein said control unit (CU) is configured to apply said first temperature T1 and said second temperature T2 as input in a calculation of a leak value LV, according to a predetermined calculation method;
wherein said control unit (CU) is configured to determine that a situation of no water consumption, as represented by a value A of flow of water of 240 TDPM (tap drops per minute) or less, is present in case LV is above a first predetermined threshold temperature TT1; and
wherein said control unit (CU), in such a situation of no water consumption, is configured to detect that no leak, as represented by a value B of flow of water of 10 TDPM or less, is present in case LV is above a second predetermined threshold temperature TT2; and wherein said control unit (CU), in such a situation of no water consumption, is configured to detect that a leak, as represented by a value C of flow of water of above the value B and below the value A, is present in case the leak value LV is above said first predetermined threshold temperature TT1 and below said second predetermined threshold temperature TT2;
wherein TT2>TT1;
wherein said leak value LV is defined as the difference T2−T1, and wherein said control unit (CU) is configured to determine and log said leak value LV.
